(19) United States
(12) Patent Application Publication
(10) Pub. No.: US 2010/0122926 A1
(43) Pub. Date: May 20, 2010

(54) TOOL BIT EXCHANGE SYSTEM AND METHOD

(76) Inventors: Anthony T. Tocco, Easley, SC (US); Thomas Evatt, Six Mile, SC (US); Lilia Macias, Anderson, SC (US); David L. Wikle, Dallastown, PA (US); Richard M. Davidian, Pickens, NC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/619,973

(22) Filed: Nov. 17, 2009

Related U.S. Application Data
(60) Provisional application No. 61/115,366, filed on Nov. 17, 2008.
(60) Provisional application No. 61/166,496, filed on Apr. 3, 2009.

(51) Int. Cl. B65D 85/00; B23P 19/04

(52) U.S. Cl. 206/379; 29/700

(57) ABSTRACT

A bit exchange system for use with a tool includes a driver bit engageable with the tool and defining an axis. Each of a plurality of adapters has a first end configured to engage the driver bit along the axis and a second end configured to retain a tool bit. Each of a plurality of tool bits is coupled to the second end of one of the plurality of adapters. A holder unit has a plurality of receptacles for receiving the plurality of adapters. Each of the plurality of adapters is insertable into and removable from the respective receptacle with a motion substantially perpendicular to the axis while engaged by the driver bit.

### CROSS-REFERENCE TO RELATED APPLICATIONS

This application claims priority to U.S. Provisional Patent Application No. 61/115,366, filed on Nov. 17, 2008 and to U.S. Provisional Patent Application No. 61/166,496, filed on Apr. 3, 2009, the entire contents of both of which are hereby incorporated by reference.

### BACKGROUND

The present invention relates to a bit exchange system for rapidly exchanging working bits into and out of connection with a tool, such as a power tool for use therewith. Previous attempts at such systems, such as that disclosed in U.S. Pat. No. 7,275,659 to Openiano, have provided for one-hand bit exchange with a power tool, but have required complexities in both the physical components and the movements required of the user during operation, which drawbacks are not shared by the present invention.

### SUMMARY

In one aspect, the invention provides a bit exchange system for use with a tool. The bit exchange system includes a driver bit engageable with the tool and defining an axis. Each of a plurality of adapters has a first end configured to engage the driver bit along the axis and a second end configured to retain a tool bit. Each of a plurality of tool bits is coupled to the second end of one of the plurality of adapters. A holder unit has a plurality of receptacles for receiving the plurality of adapters. Each of the plurality of adapters is insertable into and removable from the respective receptacle with a motion substantially perpendicular to the axis while engaged by the driver bit.

In another aspect, the invention provides a bit exchange system for use with a tool. A driver bit is engageable with a tool and defines an axis. An adapter has a first end configured to selectively engage the driver bit along the axis and a second end configured to retain a tool bit. The adapter further includes a sleeve that is axially movable between an open position that allows substantially free insertion and removal of the driver bit into and out of the first end and a closed position in which axial removal of the driver bit from the first end is inhibited. A tool bit is coupled to the second end of the adapter. A holder unit includes a receptacle configured to receive the adapter and a wedge portion adjacent the receptacle. The wedge portion is configured to wedge the sleeve from the closed position to the open position when the adapter is moved into the receptacle.

In yet another aspect, the invention provides a method of coupling and decoupling a tool bit with a tool. A driver bit is engaged with the tool. A tool bit is engaged with an adapter. The adapter and the tool bit are stored in a holder unit such that a sleeve of the adapter is held in an open position that allows substantially free insertion and removal of the driver bit into and out of the adapter. The driver bit is inserted into the adapter with a first motion while the adapter is stored in the holder unit. The adapter and the tool bit are removed from the holder unit with a second motion substantially perpendicular to the first motion. The adapter and the tool bit are returned to the holder unit with a third motion, which is substantially a reverse of the second motion. The sleeve of the adapter is wedged open by contact with the holder unit during the third motion to release a locking engagement between the driver bit and the adapter, which allows the driver bit to be freely removed from the adapter. The driver bit is disengaged from the adapter with a fourth motion, which is substantially a reverse of the first motion.

Additional features and benefits of the present invention are described and will be apparent from the accompanying drawings and description below.

### BRIEF DESCRIPTION OF THE DRAWINGS

FIG. 1 is a perspective view of a tool and bit exchange system in one configuration in which a driver bit is engaged with the tool and a plurality of adapters with tool bits are stored in a holder unit.

FIG. 2 is a perspective view of the tool and bit exchange system of FIG. 1 in a configuration in which the driver bit engages one of the adapters.

FIG. 3 is a perspective view of the tool and bit exchange system of FIG. 1 in a configuration in which the engaged adapter is removed from the holder unit for use with the tool.

FIG. 3A is a detail view of an empty receptacle of the holder unit shown in FIG. 3.

FIG. 4 is a perspective view of the tool and bit exchange system of FIG. 1 in a configuration in which the engaged adapter is returned to the holder unit after use with the tool.

FIG. 5 is a perspective view of the tool and bit exchange system of FIG. 1 in a configuration in which the driver bit is disengaged from the one adapter and moved toward a second one of the adapters.

FIG. 6 is a perspective view of the tool and bit exchange system of FIG. 1 in a configuration in which the driver bit engages the second one of the adapters.

FIG. 7 is a perspective view of the tool and bit exchange system of FIG. 1 in a configuration in which the second adapter is removed from the holder unit for use with the tool.

FIGS. 8A-8D illustrates various means for supporting the holder unit similar to that of the tool and bit exchange system of FIGS. 1-7.

FIG. 9 illustrates a modified holder unit for the tool and bit exchange system of FIGS. 1-7.

FIG. 10 illustrates modified bit adapters for the tool and bit exchange system.

FIGS. 11 and 12 illustrate an alternate tool and bit exchange system including a holder unit coupled with a glove-type article.

FIG. 13 illustrates a tool and bit exchange system similar to that of FIGS. 11 and 12, including a modified holder unit.

FIG. 14 is an exploded perspective view of a clamp according to one aspect of the invention.

FIG. 15 is a perspective view of the clamp of FIG. 14 clamped to a planar object.

FIG. 16 is a side view of the clamp of FIG. 14 attached to the object of FIG. 15.

FIG. 17 is a perspective view of the clamp in a closed position.

FIG. 18 is a perspective view of the clamp of FIG. 14 with a tool and bit exchange system similar to the one of FIGS. 1-13 attached.

FIG. 19 is a perspective view of an upper jaw of the clamp of FIG. 1, including a movable attachment interface.

FIG. 20 is a perspective view of the upper jaw of the clamp of FIG. 1, including the movable attachment interface of FIG. 19 rotated to a second position.

FIG. 21 is a perspective view of the movable attachment interface of FIG. 19.

FIG. 22 is a top perspective view of the upper jaw of FIG. 19 with the movable attachment interface removed.

FIG. 23 is a perspective view of the upper jaw of the clamp of FIG. 1, including a second movable attachment interface.

FIG. 24 is a perspective section view of the upper jaw of the clamp of FIG. 1, including the second movable attachment interface of FIG. 23.

FIG. 25 is a perspective view of the upper jaw of the clamp of FIG. 1, including the second movable attachment interface of FIG. 23 rotated to a second position.

FIG. 26 is a perspective view of the upper jaw of the clamp of FIG. 1, including the second movable attachment interface of FIG. 23 rotated to a third position.

FIG. 27 is a perspective view of an alternate driver bit for use with a tool and bit exchange system.

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

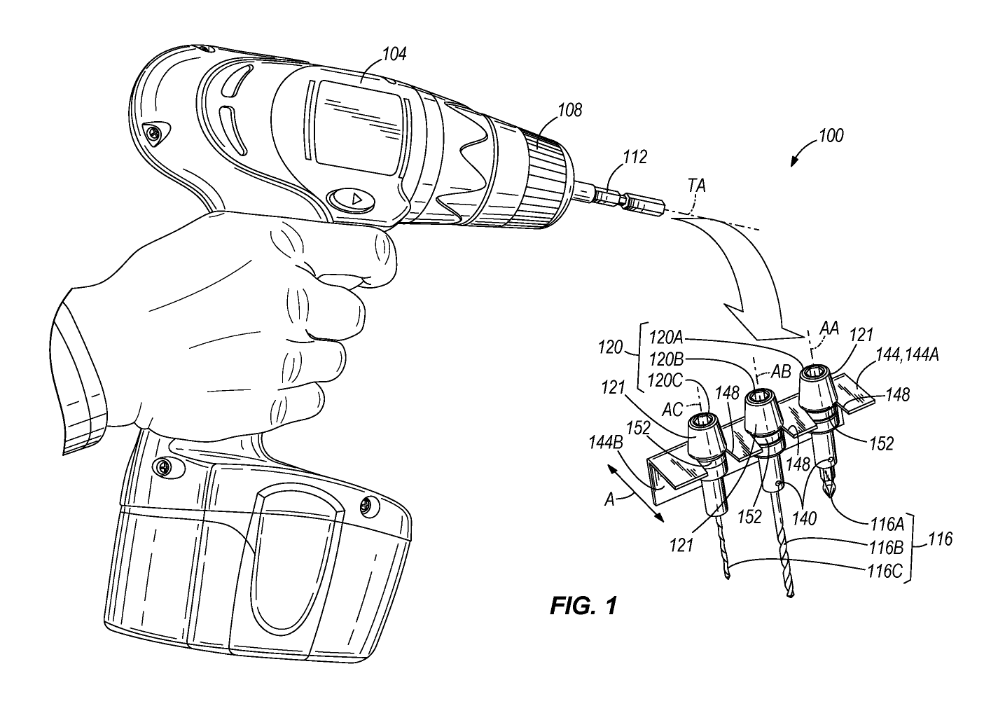

FIGS. 1-7 illustrate a tool and bit exchange system 100 including a tool such as a drill/driver 104 having a chuck 108. The chuck 108 is closable to releasably engage a driver bit 112 to be rotated by the drill/driver 104. Various tool bits 116 are provided as part of the system 100. As shown in the figures, the tool bits 116 may include a screwdriver bit 116A associated with a first adapter 120A, a drill bit 1168 associated with a second adapter 120B, and an additional drill bit 116C associated with a third adapter 120C. The driver bit 112 is configured to engage any one of a plurality of bit adapters 120 so that the chuck 108 does not need to be released and re-engaged for every bit change.

In some constructions, a mechanical device is provided for coupling and de-coupling the driver bit 112 and any one of the adapters 120. Such a mechanical device can be a spring-biased ball or other type detent mechanism that provides a positive engagement between one or more balls and a groove. Such a mechanical device can be similar to one of those disclosed in U.S. Pat. No. 6,457,916 and U.S. Pat. No. 6,561,523, both of which are incorporated herein by reference. As with the devices of the two above-mentioned patents, an exterior sleeve 121 can be provided to change the mechanical device from a locked or closed state to an unlocked or open state. In the locked or closed state, the driver bit 112 and the adapter 120 are inhibited or prevented from being pulled apart, while the driver bit 112 is freely insertable into and removable from the adapter 120 when in the unlocked or open state. Alternately, other means can be provided to selectively inhibit and allow separation of the driver bit 112 from the adapters 120. For example, the device need not be a detent mechanism and can instead be a one-way linear bearing or other type mechanism that inhibits axial decoupling of the driver bit 112 and an engaged adapter 120 when the sleeve 121 is in the locked or closed position. In such a construction, no groove is required in the shank of the driver bit 112, since the resistance to disengagement is provided by balls or rollers that bind to prevent axial removal of the driver bit 112 until the sleeve 121 is moved to the unlocked or open position.

Each one of the adapters 120 has a first end configured to engage the driver bit 112 for rotational driving engagement. In particular, the adapters 120 of the illustrated construction include openings at the first ends that have a shape that corresponds to the shape of the driver bit 112 (e.g., hex, double-hex, Torx, etc.) and is capable of transmitting torque from the driver bit 112 to the adapter 120. A second end of each adapter 120 opposite the first end is configured to receive a tool bit 116 and enable torque to be transmitted from the adapter 120 to the tool bit 116. The first adapter 120A is provided with a hex-shaped receptacle to receive a drive portion of the screwdriver bit 116A. The second and third adapters 120B, 120C can be provided with round openings sized to receive the respective drill bits 116B, 116C. Additional adapters 120 can be provided as part of the system 100 to be used with one or more additional tool bits 116.

Each adapter 120 can include a locking mechanism 140, such as a set screw, to prevent the respective bit 116 from becoming inadvertently separated from the adapter 120 and/or to prevent relative rotation between the bit 116 and the adapter 120. The locking mechanism 140 can include, among other things, a magnetic device, a ball detent arrangement, or a miniature multi-jaw chuck as alternatives to set screws. Although not shown, the third adapter 120C also includes a locking mechanism 140 to engage the drill bit 116C. The tool bits 116 can be substantially conventional tool bits 116 so that the benefits of the invention may be realized with a user's existing tool bits 116. Furthermore, at least the first adapter 120A is configured to receive any one of a plurality of different tool bits that have a common hex-shaped drive portion.

All of the adapters 120 of the system 100 are able to be stored in a holder unit 144 for easy access. The holder unit 144 includes a receptacle 148 for each adapter 120. As shown in the figures, each adapter 120 may include a groove or relief 152 at a central portion that is sized to engage the edge of one of the receptacles 148 so that the adapters 120 are movable into and out of the storage position on the holder unit 144 along the directions of double arrow A (FIG. 1), and the adapters 120 are otherwise securely supported within the receptacles 148.

Although other shapes are optional, the illustrated holder unit 144 is generally L-shaped, having a first portion 144A with the receptacles 148 and a second portion 144B extending at a substantially 90 degree angle from the first portion 144A. The adapters 120 can be retained with the holder unit 144 by a magnetic retention mechanism to inhibit incidental release of the adapters 120 from the respective receptacles 148. The attraction of the adapters 120 to one or more magnets on the holder unit 144 is strong enough to prevent the adapter 120 from falling out of the receptacle 148, but weak enough to easily be overcome by an average user when a user makes an effort to remove the adapter 120 from the receptacle 148. Alternatively, mechanical retention mechanisms can be provided to retain the adapters 120 on the holder unit 144. Such mechanical retention mechanisms may include resilient clips, hook-and-loop strips, etc., none of which require a user to grasp or otherwise engage the holder unit 144 in order to release the adapters 120 from the holder unit 144.

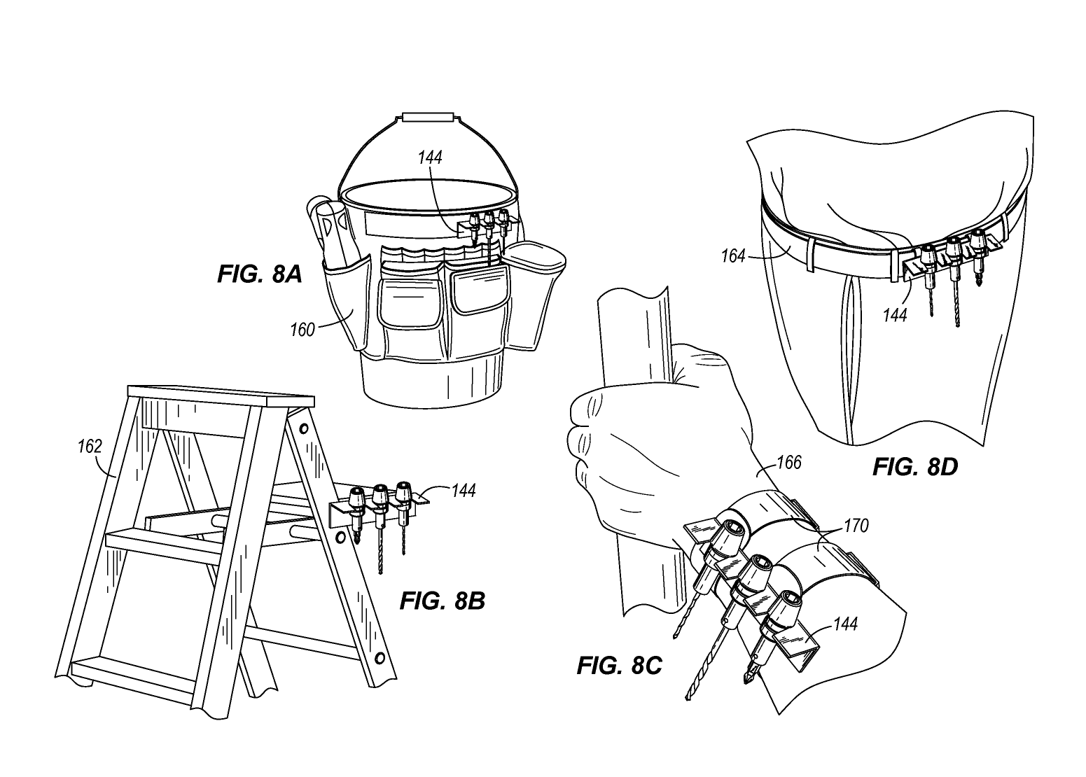

As shown in FIG. 8, the holder unit 144 may be supported in a variety of convenient locations for storage and/or access during a work task. By way of example, FIG. 8 illustrates the holder unit 144 supported on a bucket tool organizer 160, a step ladder 162, a user's belt 164, and a user's wrist 166. The holder unit 144 can be provided with one or more clips (not shown) that enable easy attachment to a variety of support structures (including those shown in FIG. 8). As configured to be supported on a user's wrist 166, the holder unit 144 can be provided with one or more wrist straps 170 that secure the holder unit 144 to the user's wrist 166. In some constructions, the wrist straps 170 may be releasably secured to the holder unit 144 by the same clips that enable the holder unit to be supported on a belt 164 or other structure. In other constructions, the wrist straps 170 are coupled to the holder unit 144 by alternate fasteners or made integral (i.e., non-releasably fixed) with the holder unit 144. The wrist straps 170 can wrap around the user's wrist 166 and be secured with hook-and-loop strips, clasps, buckles, etc.

The illustrated tool and bit system 100 enables a user to complete a task requiring multiple tool bits 116 quicker and more easily than previously possible. First, the user loads the required tool bits 116 into the adapters 120 by inserting the tool bits 116 into the adapters 120 and locking them in place, with the locking mechanisms 140 if necessary. Once the adapters 120 are loaded with the tool bits 116, the adapters 120 are loaded into the holder unit 144. Although the holder unit 144 is illustrated with three receptacles 148 for three adapters 120, the system 100 can include more adapters 120 for additional tool bits 116, and the holder unit 144 may be provided with one, two, or more than three receptacles 148.

The user loads the driver bit 112 into the chuck 108 of the drill/driver 104 so that the driver bit 112 is aligned with the tool's axis TA and is configured to be rotated about the axis TA with the chuck 108 when the drill/driver 104 is energized. The user secures the holder unit 144 at a convenient location, including for example on the body of the user, for access during the work task. When the holder unit 144 is provided with the wrist straps 170, the holder unit 144 is supported on the wrist 166 of the user opposite the hand used to operate the drill/driver 104. When the holder unit 144 is coupled to the user's belt 164, the user may choose to locate the holder unit 144 on the same side of the body as the hand used to operate the drill/driver 104.

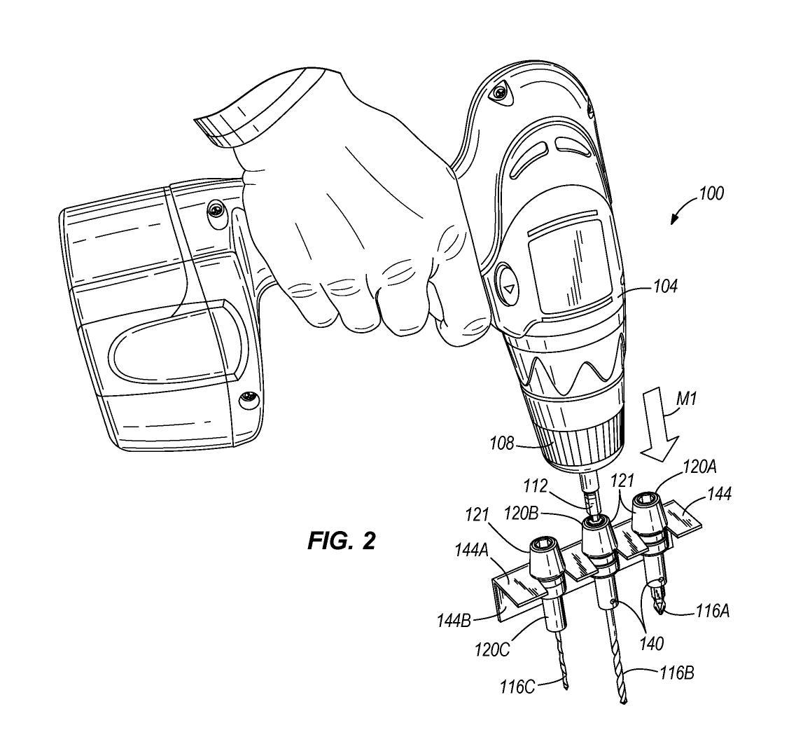

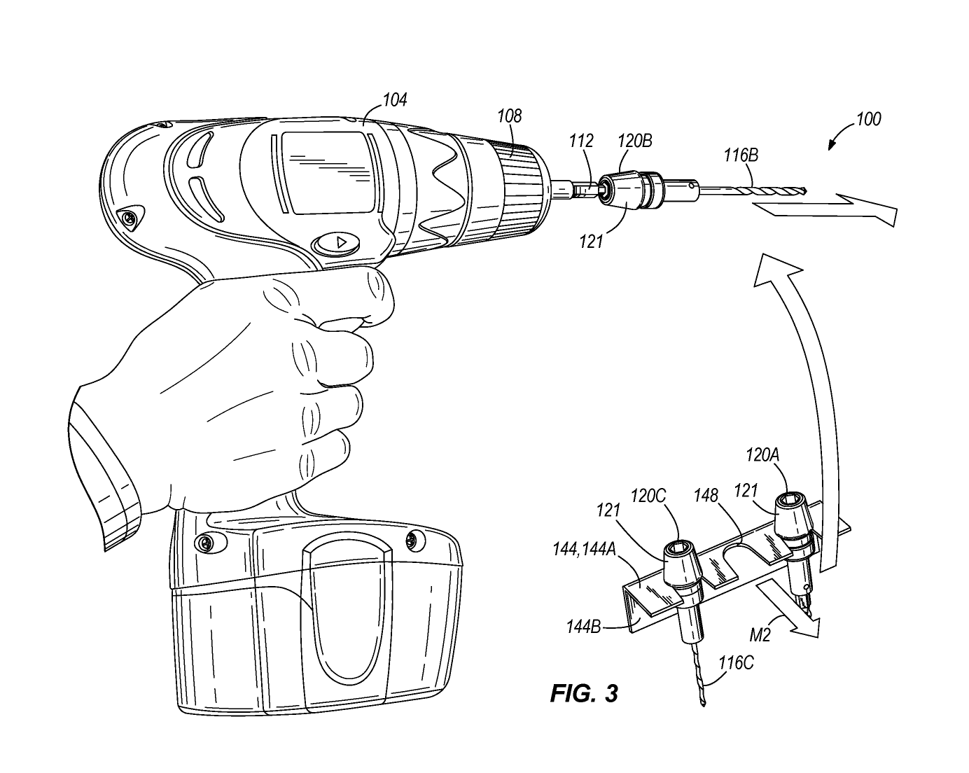

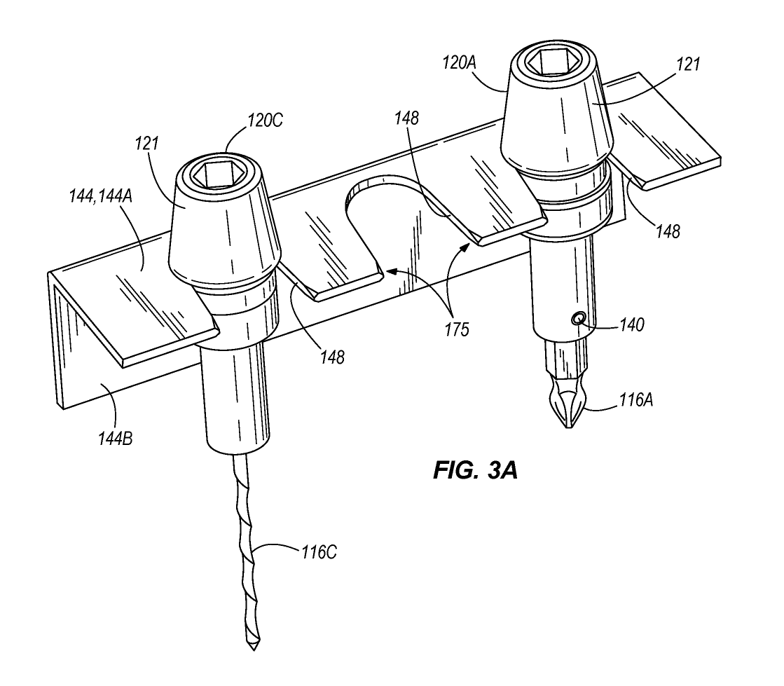

As shown in FIGS. 1 and 2, the user aligns the tool axis TA with an axis AB of the desired adapter 120B and moves the drill/driver 104 with a first motion M1 (FIG. 2, substantially parallel to the axis AB) toward the holder unit 144. The axis AB of the adapter 120B is shared with the tool bit 116B associated therewith. With the first motion M1 of the drill/driver 104, the driver bit 112 is inserted into the adapter 120B that is loaded with the first desired tool bit 116B. The holder unit 144 holds the adapter 120B stationary while the driver bit 112 is coupled to the adapter 120B. As shown in FIG. 3, the user slides the adapter 120B out of the receptacle 148 with a second motion M2 (FIG. 3, substantially perpendicular to the tool axis TA and the adapter axis AB) to disengage the adapter 120B from the holder unit 144. As long as the holder unit 144 is properly secured, the user is able to load the adapter 120B onto the driver bit 112 and release the adapter 120B from the holder unit 144 with a single hand, while the other hand is free and can be used to hold another tool, a fastener, or the workpiece, among other things. Once the first selected adapter 120B is released from the holder unit 144, the user uses the first selected tool bit 116B by operating the drill/driver 104.

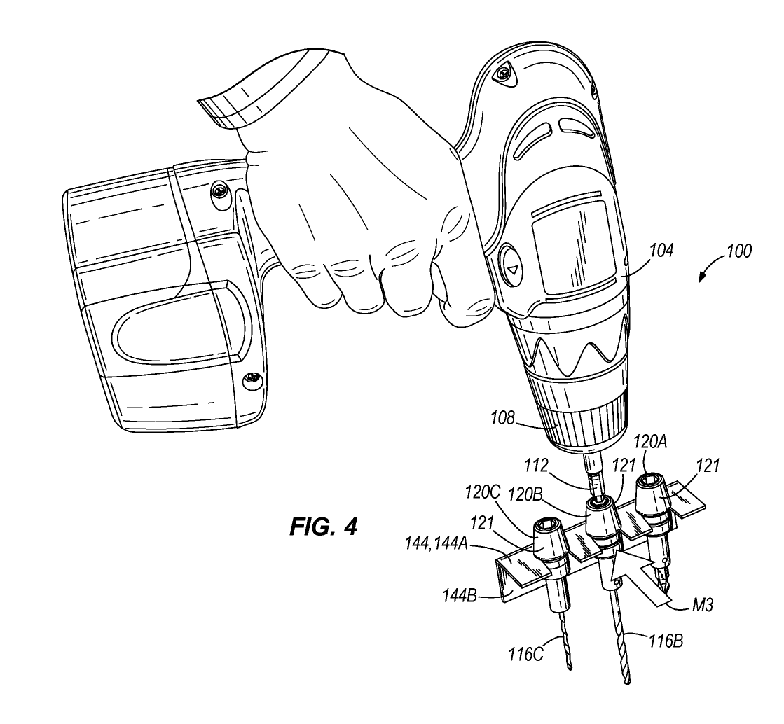

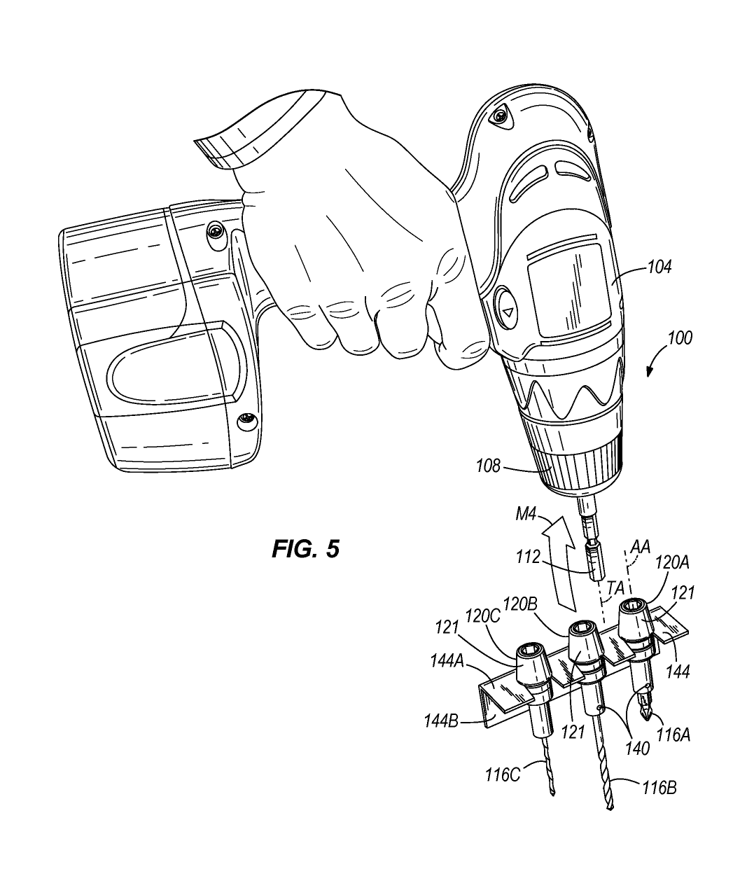

When the task of the first selected tool bit 116B is complete and the user requires another of the tool bits 116A, 116C, the user returns the first selected adapter 120B (still engaged with the driver bit 112) to the holder unit 144 as shown in FIG. 4. The user slides the adapter 120B with a third motion M3 (FIG. 4, substantially a reverse of the second motion M2) into a/the vacant receptacle 148 such that the groove 152 in the adapter 120B is engaged by the holder unit 144. When the adapter 120B is fully seated into the receptacle 148, the user pulls the driver bit 112 (still in engagement with the chuck 108) out of engagement with the adapter 120B by a fourth motion M4 (FIG. 5, substantially a reverse of the first motion M1). The adapter 120B is held fixed with the holder unit 144 via the groove 152 as the user makes the fourth motion M4 to retract the driver bit 112.

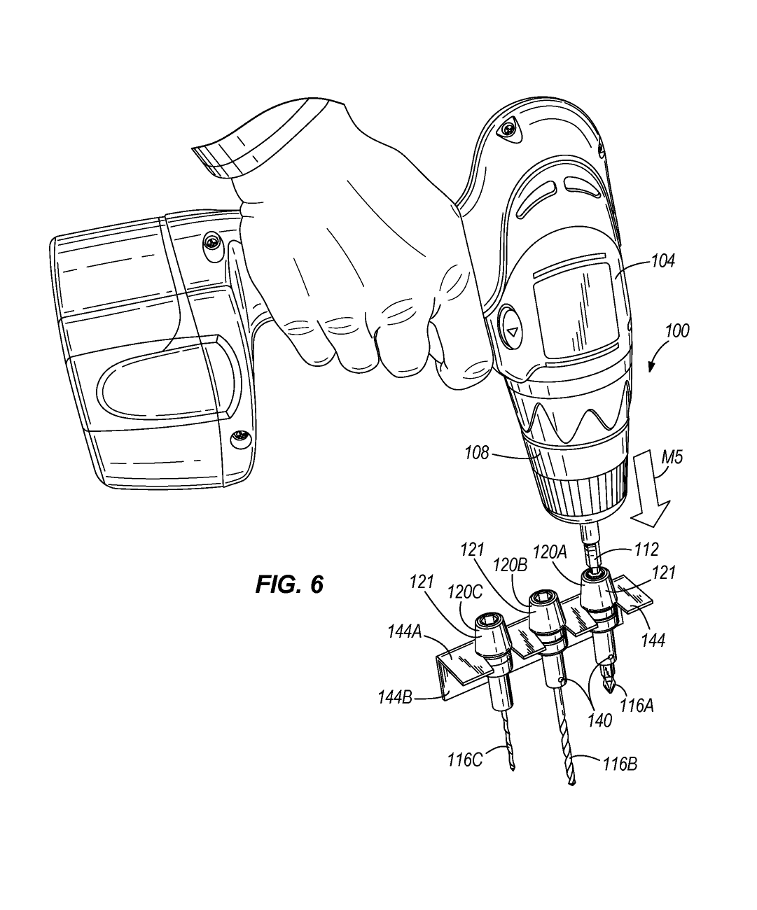

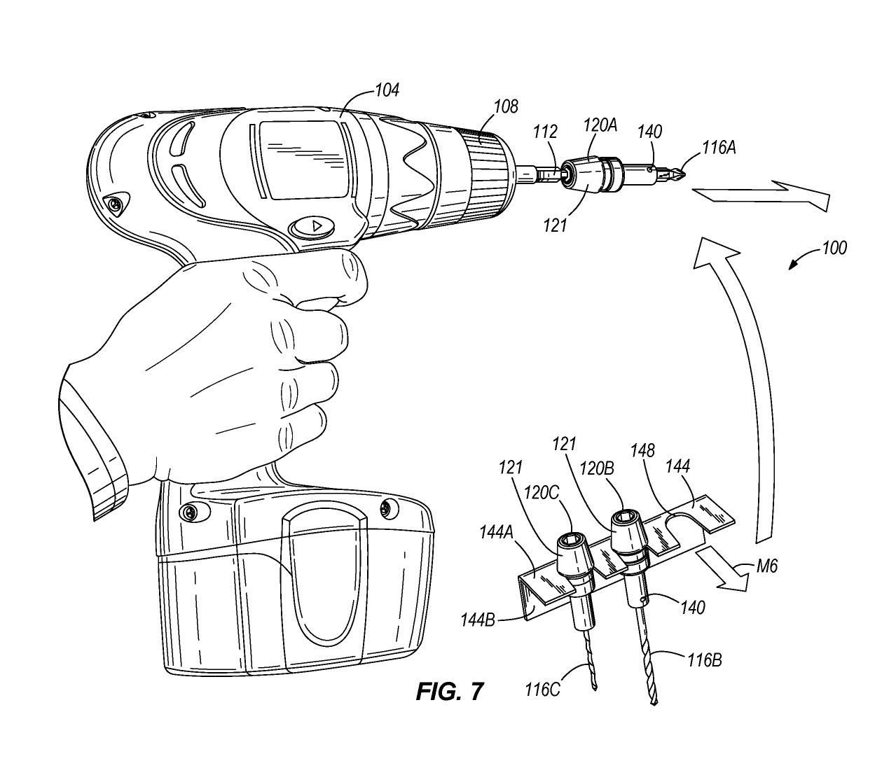

As shown in FIGS. 5 and 6, the user moves the driver bit 112 over to align the tool axis TA with the axis AA of the adapter 120A containing the next desired tool bit 116A. The user then inserts the driver bit 112 into the adapter 120A with a fifth motion M5 (FIG. 6, substantially parallel to the tool axis TA and the axis AA of the adapter 120A). The adapter 120A is removed from the holder unit 144 with a sixth motion M6 (FIG. 7, substantially perpendicular to the tool axis TA and the adapter axis AA), and the user uses the second selected tool bit 116A for the next task.

From the time that the driver bit 112 is loaded into the chuck 108 and the holder unit 144 is loaded with adapters 120 loaded with the required tool bits 116, the user only requires the use of a single hand to arm the drill/driver 104 with the first tool bit 116B, remove the tool bit 116B from its stored position, operate the drill/driver 104, return the tool bit 1168 to its stored position, and exchange the first tool bit 1168 for the second tool bit 116A. The particular task of the user may require exchanging between more than two tool bits 116 and/or exchanging back and forth between the same tool bits 116 repeatedly. Thus, a great deal of time and effort is saved by the tool and bit exchange system 100 when multiple tool bits 116 must be exchanged for sequential use with the drill/driver 104. Although the figures illustrate the tool as being a drill/driver 104, the invention can be adapted for use with other power tools. Likewise, the invention can be useful for manual tools as well.

In some constructions, a positive engagement (e.g., by a ball and groove detent or other mechanism) between the driver bit 112 and the first end of one of the adapters 120 can be established or broken while the adapter is stored or held fixed in the holder unit 144. In a construction where the adapters 120 are equipped with axially movable sleeves 121 that must be moved to cause the establishment or breaking of a positive engagement between the driver bit 112 and the adapter 120, a feature of the holder unit 144 may be provided to automatically move the sleeve 121 when the adapter 120 is moved into and out of engagement with the holder unit 144. As shown in FIG. 3A, the holder unit 144 can be provided with a wedge portion 175 adjacent the receptacle 148. The wedge portion 175 is configured to wedge the sleeve 121 of the adapter 120B from the locked or closed position (to which it may be biased) to the unlocked or open position as the adapter 120B is inserted into the receptacle 148 (i.e., moved with the third motion M3 perpendicular to the axes TA and AB). In the illustrated construction, the wedge portion 175 constitutes a change in thickness in the first portion 144A of the holder unit 144. Wedge portions like that shown in FIG. 3A can be provided on both sides of each receptacle 148 in the holder unit 144. Once wedged to the unlocked or open position by insertion of the adapters 120 into the receptacles 148, the holder unit 144 retains the sleeve 121 of each of the adapters 120 in the unlocked or open position until eventually removed for use with the drill/driver 104.

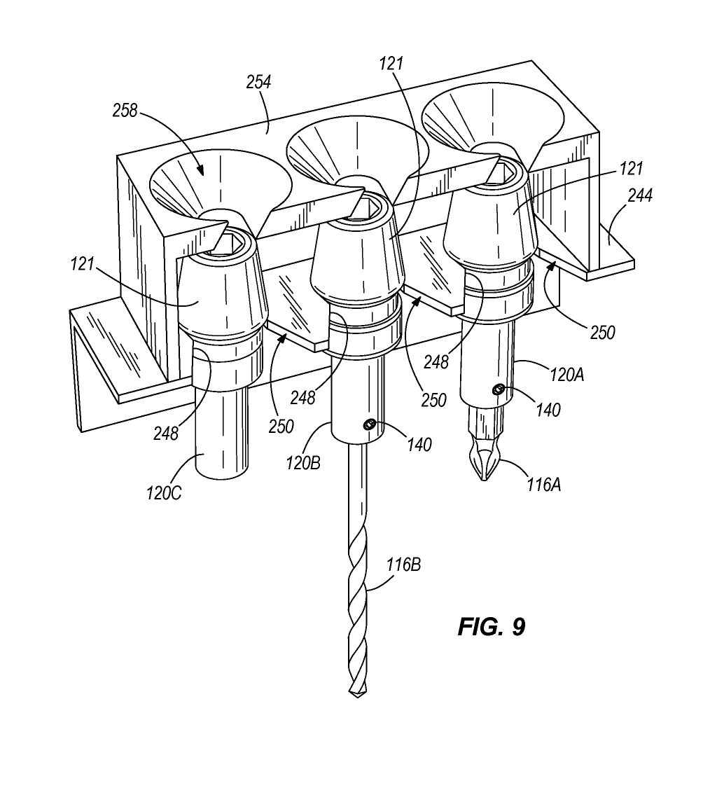

FIG. 9 illustrates a modified holder unit 244 including receptacles 248 having flared openings 250 to make it easier for the user to insert the adapters 120 into the receptacles 248. The flared openings 250 make it easier for the user to exchange between tool bits 116 “by feel” without looking towards the holder unit 244. Furthermore, the modified holder unit 244 includes a cap 254 having funnels 258 above each receptacle 248 to help guide the driver bit 112 into the corresponding opening in the desired adapter 120. The cap 254 may include labels (not shown) including letters, words, and/or numbers that are indicative of the tool bit 116 contained in each adapter 120 to help the user identify the funnel 258 into which the driver bit 112 must be inserted to arm the drill/driver 104 with the desired tool bit 116.

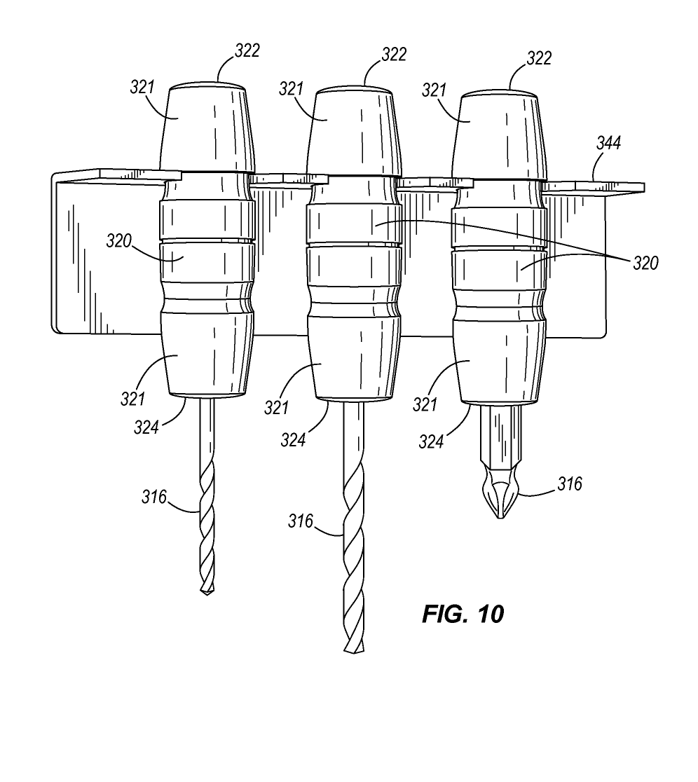

FIG. 10 illustrates a set of modified adapters 320 in a holder unit 344 similar to the holder unit 144 of FIGS. 1-8. The adapters 320 are provided with first ends 322 configured to receive a driver bit (similar to the driver bit 112, for example) and second ends 324 configured to receive drive portions of the respective tool bits 316. The tool bits 316 are provided with non-round drive portions (e.g., hex-shaped shanks) that engage non-round openings in the second ends 324. A mechanical device, which can be similar to those disclosed in U.S. Pat. No. 6,457,916 and U.S. Pat. No. 6,561,523 in some constructions, can be provided at the second ends 324 of the adapters 320 in addition to the first ends 322. Accordingly, both ends 322, 324 can be provided with movable sleeves 321 that selectively allow the release of the driver bit and tool bits 316, respectively. Thus, loading of the tool bits 316 into the adapters 320 is not only simplified, but the adapters 320 are substantially “universal” to accept all or at least a large number of tool bits 316 (which can include more than those illustrated). Although each tool bit 316 may be provided with a circumferential groove to receive a ball of a detent mechanism as shown in the two above-mentioned patents, a groove need not be provided in the shank if the mechanical device at each end the adapter 120 is configured as a one-way linear bearing with balls or rollers that bind and prevent axial removal of the driver bit or tool bits 316 until the corresponding sleeve 321 is moved to the unlocked or open position.

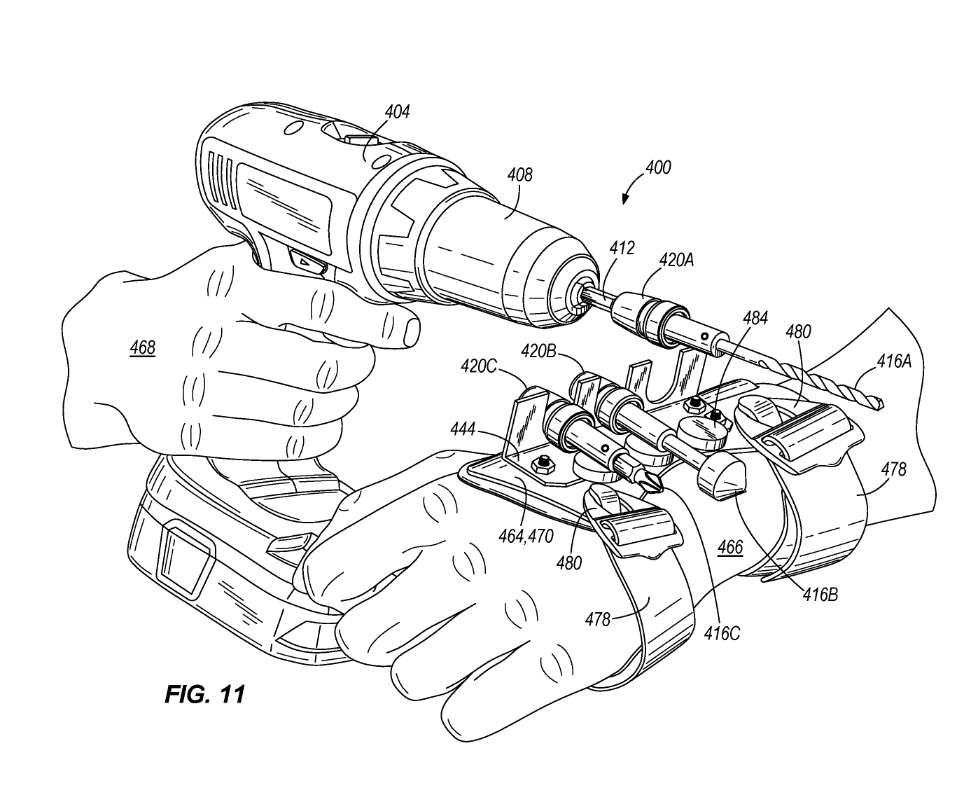

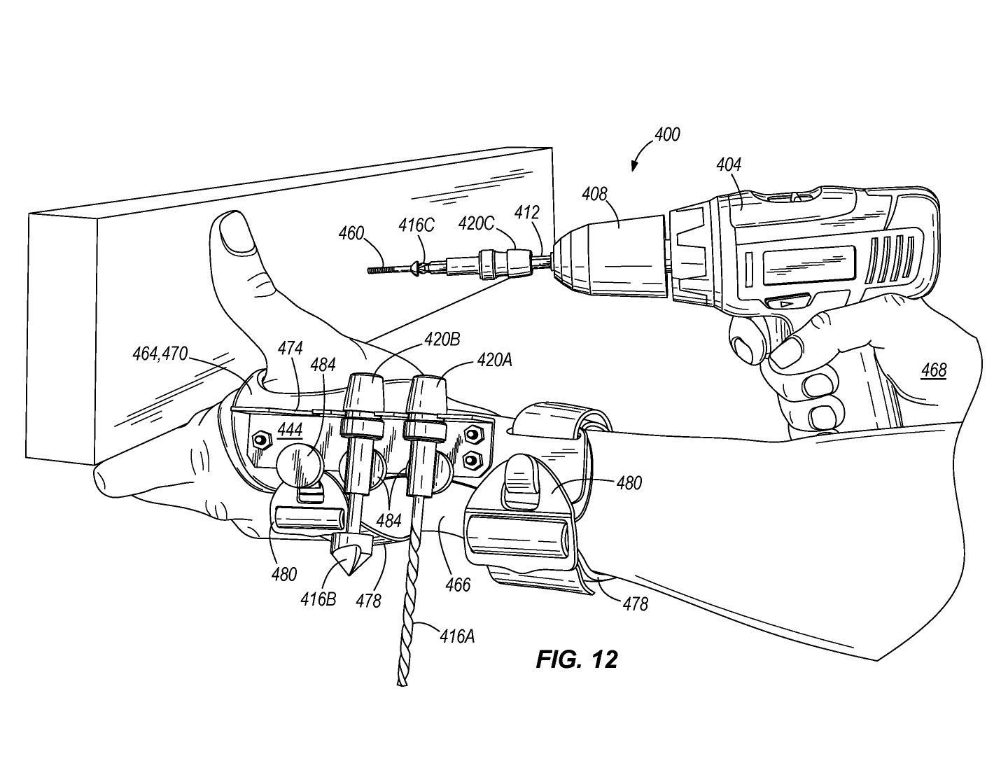

FIGS. 11 and 12 illustrate an alternate tool and bit exchange system 400 including a drill/driver 404 with a chuck 408, a driver bit 412, a holder unit 444, a plurality of bit adapters 420 storable in the holder unit 444, and a plurality of tool bits 416 associated with the adapters 420. The tool and bit exchange system 400 is similar to the system 100 of FIGS. 1-7, except as noted below. Similar reference numbers are used where appropriate, with a different leading digit. A tool and bit exchange system of the present invention may include combinations of features shown in separate physical constructions.

In the illustrated construction the plurality of tool bits 416 includes a drill bit 416A, a countersinking bit 416B, and a screwdriver bit 416C. The illustrated combination of tool bits 416 can be used to drill a hole in a workpiece, countersink the hole, and drive a fastener 460 into the countersunk hole. As with the system 100 of FIGS. 1-7, the system 400 of FIGS. 11 and 12 allows the user to repeatedly exchange the tool bits 416 with which the drill/driver 404 is armed with a single hand and without operating the chuck 408, or grasping the adapters 420 or the tool bits 416.

The holder unit 444 of FIGS. 11 and 12 is coupled with a glove-type article 464 configured to be worn on the hand/wrist area 466 of the user opposite the hand 468 that is used to operate the drill/driver 404. The article 464 includes a body portion 470 to which the holder unit 444 is attached. The article 464 further includes a thumb hole 474 and a pair of straps 478 with clasps 480. The straps 478 are elastic and/or length-adjustable. The thumb hole 474 offers the user great control of the holder device 444 during exchange of the adapters 420.

As described, but not illustrated, with respect to the system 100 of FIGS. 1-7, the holder unit 444 includes magnets 484 configured to retain the adapters 420 until needed by the user. The magnets 484, which are disc-shaped (but can be otherwise shaped), are coupled to the second portion 444B of the holder unit 444.

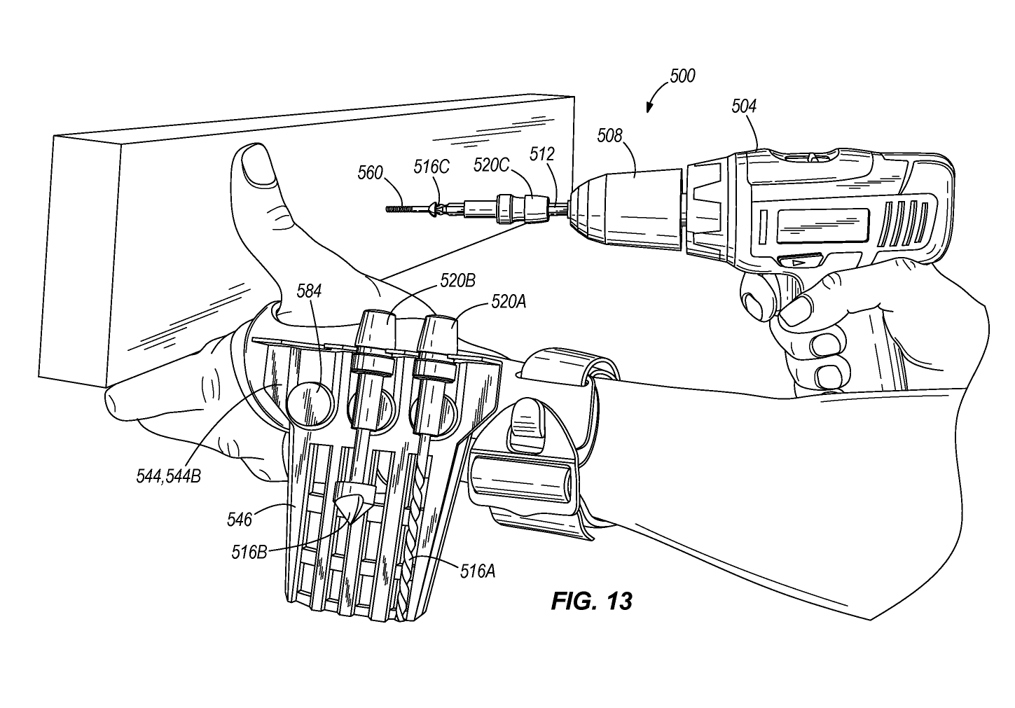

FIG. 13 illustrates a tool and bit exchange system 500 similar to those of FIGS. 1-7 and FIGS. 11-12, including a modified holder unit 544. Similar reference numbers are used where appropriate, with a different leading digit. The holder unit 544 includes a guard portion 546 that extends from the second portion 544B in the direction of extension of the stored tool bits 516. The guard portion 546 can extend about the same length as the longest tool bit 516A. The guard portion 546 can be molded from plastic, although other materials and manufacturing methods are optional. The guard portion 546 substantially covers the tool bits 516 from at least one side to prevent incidental contact between the tool bits 516 and nearby objects and/or people, including the user.

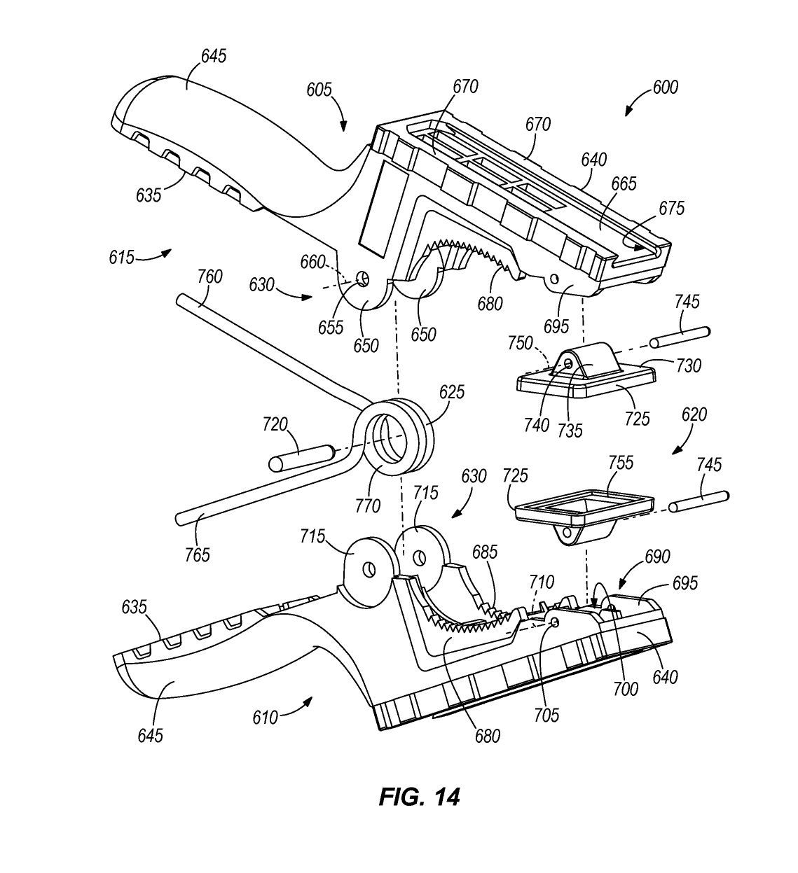

FIG. 14 illustrates a clamp 600 that can be used in conjunction with or separate from an accessory, such as the holder unit 144 of the bit exchange system 100 of FIGS. 1-7, among others. The clamp 600 includes an upper jaw 605 and a lower jaw 610 that pivotally attach to one another to define a handle end 615 and a jaw end 620 that are movable between a closed position and an open position. A biasing member 625 is positioned to bias the jaw end 620 toward the closed position.

The upper jaw 605 includes an attachment region 630, a handle region 635, and a jaw region 640. The handle region 635 includes a curved outer surface 645 shaped to fit within the palm of a user's hand. In preferred constructions, the handle region 635 is substantially hollow and is sized to receive a portion of the biasing member 625. Of course other constructions could employ a solid handle region or partially hollow region if desired.

The attachment region 630 is positioned between the handle region 635 and the jaw region 640. The attachment region 630 includes two ears 650 that include an aperture 655 that passes through both ears 650 along a pivot axis 660.

The jaw region 640 includes an outer surface 665 that is substantially planar and that is adapted to receive an accessory, such as the holder unit 144 of the bit exchange system 100 of FIGS. 1-7, for example. Two side members 670 cooperate with the outer surface 665 to define a dovetail fit 675 for receiving the accessory. Of course other attachment arrangements could be employed if desired.

The jaw region 640 includes a pair of curved surfaces 680 opposite the outer surface 665 and adjacent the attachment region 630. The curved surfaces 680 include a plurality of serrations or teeth 685 that cooperate to more firmly secure the clamp 600 to a cylindrical object as will be discussed. In the illustrated construction, two curved surfaces 680 support the teeth 685. However, other constructions could employ a single surface 680 or three or more surfaces 680 if desired.

The jaw region 640 also includes a pad attachment portion 690 opposite the outer surface 665 and adjacent the curved surfaces 680. The pad attachment portion 690 includes two attachment ears 695 that extend substantially normal to the outer surface 665 and define a space 700 therebetween. An aperture 705 passes through both ears 695 and defines a pad pivot axis 710 that is substantially parallel to the pivot axis 660.

The lower jaw 610 is substantially the same as the upper jaw 605. However, the attachment region 630 of the lower jaw 610 includes two ears 715 that are offset with respect to the ears 650 of the upper jaw 605. In the illustrated construction, the lower ears 715 are offset inward, toward a bisecting plane of the jaw 610. The offset allows the ears 650 of the upper jaw 605 to pass outside of the ears 715 of the lower jaw 610 to align the pivot axes 710 (and the apertures 705) of the upper jaw 605 and lower jaw 610. Once aligned, a pivot pin 720 is inserted through the apertures 705 in the four ears 650, 715 and the upper jaw 605 and lower jaw 610 are pivotally attached to one another.

Pivot pads 725 are pivotally attached to each of the upper jaw 605 and the lower jaw 610 to facilitate clamping to planar objects. Each pad 725 includes a substantially rectangular portion 730 and an attachment boss 735 extending from the rectangular portion 730. The attachment boss 735 includes an aperture 740 that passes through the boss 735. The boss 735 is sized to fit within the space 700 between the attachment ears 695 of the upper jaw 605 and lower jaw 610. When positioned within the space 700, the boss aperture 740 aligns with the apertures 705 in the ears 695 to allow for the insertion of a pivot pin 745. Once positioned, the pin 745 provides a pivot axis 750 for the pad 725 which allows the pad 725 to pivot with respect to the remainder of the clamp 600. It should be noted that while the illustrated pads 725 include a rectangular portion 730, other constructions may employ other shapes as desired.

In the illustrated construction, each pad 725 includes an engagement surface 755 opposite the boss 735. The engagement surface can be a planar surface, or could be a roughened surface designed to increase the friction between the clamp 600 and the surface to which it is being attached. In still other constructions, a friction enhancing member is attached to the engagement surface 755. For example, in one construction a rubber pad is bonded to the engagement surface 755 to improve the clamping ability of the clamp 600.

The biasing member 625 includes a torsional spring that is positioned between the upper jaw 605 and the lower jaw 610. The torsional spring includes a first arm 760, a second arm 765, and a coil portion 770. The coil portion 770 is positioned adjacent the attachment region 630 of the jaws 605, 610 and is held in a fixed position with respect to the jaws 605, 610. The first arm extends along the upper jaw 605 and is positioned within the hollow handle region 635. The second arm 765 is similarly positioned within the hollow handle region 625 of the lower jaw 610.

In operation, the user grasps the handle region 635 of the two jaws 605, 610 when the clamp 600 is in the position illustrated in FIG. 17. The user squeezes the two handle regions 635 toward one anther to open the jaw regions 640 of the clamp 600 and to overcome the biasing force of the biasing member 625. Once opened, the user positioned the jaw regions 640 around the object to be clamped and releases the two handle regions 635. The biasing member 625 moves the jaw regions 640 toward a closed position until the pads 725 contact the object being clamped. The pads 725 are free to pivot slightly to accommodate clamping to objects without parallel surfaces. Once clamped, the biasing member 625 provides the necessary clamping force to hold the clamp 600 in position.

A similar process is followed to clamp to a cylindrical object such as a pipe. However, rather than the pads 725 contacting the pipe, the teeth 685 of the curved surfaces 680 contact the pipe and provide sufficient grip to inhibit unwanted movement.

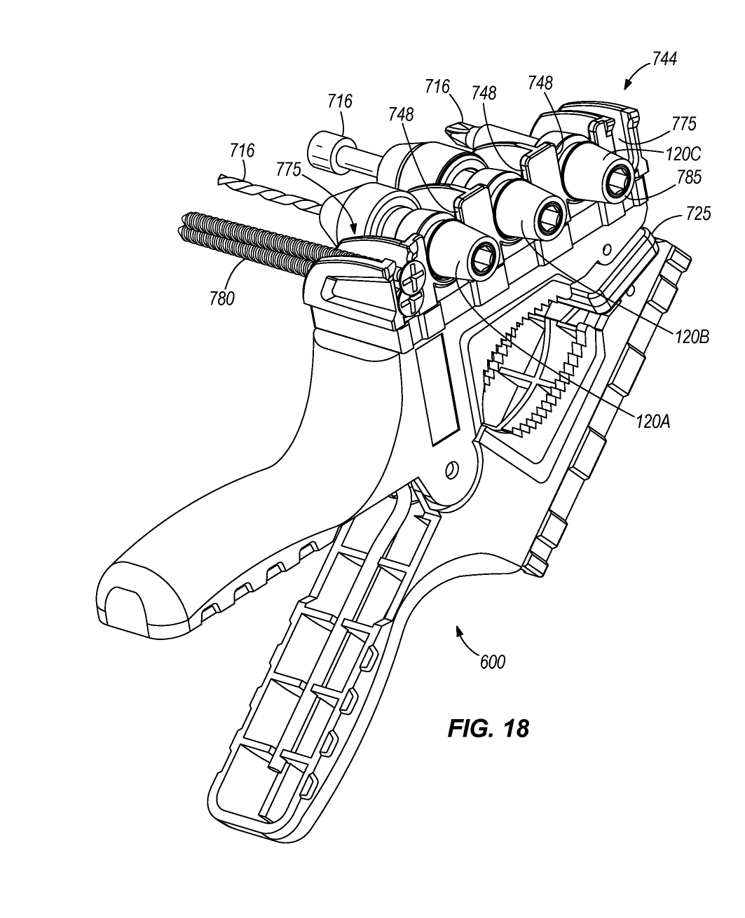

Turning to FIG. 18, the clamp 600 of FIG. 1 is shown with a holder unit 744 of a bit exchange system that is similar to the holder unit 144 of the bit exchange system 100 illustrated in FIGS. 1-7. The illustrated holder unit 744 includes three receptacles 748 that support three separate adapters 120A-C that are loaded with three tool bits 716 that may be needed for a particular operation. In addition, two smaller receptacles 775 are positioned outside of the receptacles 748 and are configured to hold other objects such as screws 780.

The holder unit 744 of FIG. 18 includes a dovetail fit portion 785 that engages the dovetail fit 675 of the clamp 600 to hold the holder unit 744 in place relative to the clamp 600. In other constructions, other attachment means may be employed. For example, fasteners, hook and loop type fasteners (VELCRO), and the like could be employed in place of, or in conjunction with the dovetail 675, 785. In still other constructions, magnets are used to magnetically connect the holder unit 744 to the clamp 600.

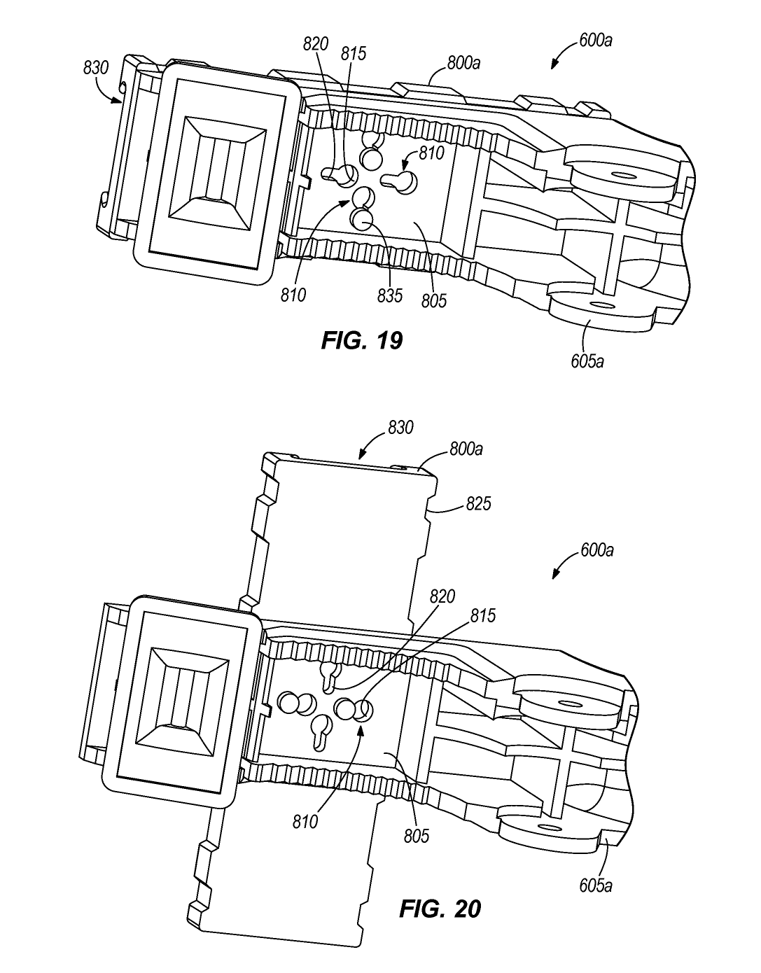

FIGS. 19-22 illustrate an additional construction in which an upper jaw 605a of a clamp 600a includes a substantially planar top surface 790 that receives a movable attachment interface 800 that is arranged to support a holder unit, such as the holder unit 744, of a bit exchange system. As illustrated in FIGS. 19 and 20, the upper jaw 605a includes a second substantially planar surface 805 opposite the top surface 790, such that the wall thickness from the top surface 790 to the bottom surface 805 is substantially uniform.

FIGS. 19-22 illustrate one construction of the upper jaw 605a for the clamp 600a that includes a first movable attachment interface 800a. With reference to FIG. 22, the upper jaw 605a (and the lower jaw if desired) includes several apertures 810 formed in the planar top surface 790 to receive the movable attachment interface 800a. Each aperture 810 includes a large diameter portion 815 and a smaller diameter slot portion 820 extending from one side of the large diameter portion 815. As illustrated in FIGS. 19 and 20, the apertures 810 pass through the upper jaw 605a and through the top planar surface 790 and the second planar surface 805.

In the illustrated construction, the apertures 810 are arranged in pairs. For each pair, the slots 820 extend from the large diameter portion 815 in the same direction. The illustrated construction includes two pairs arranged at about 90 degrees with respect to one another, with other constructions being arranged at different angles and/or including additional, or fewer, pairs of apertures 810 if desired.

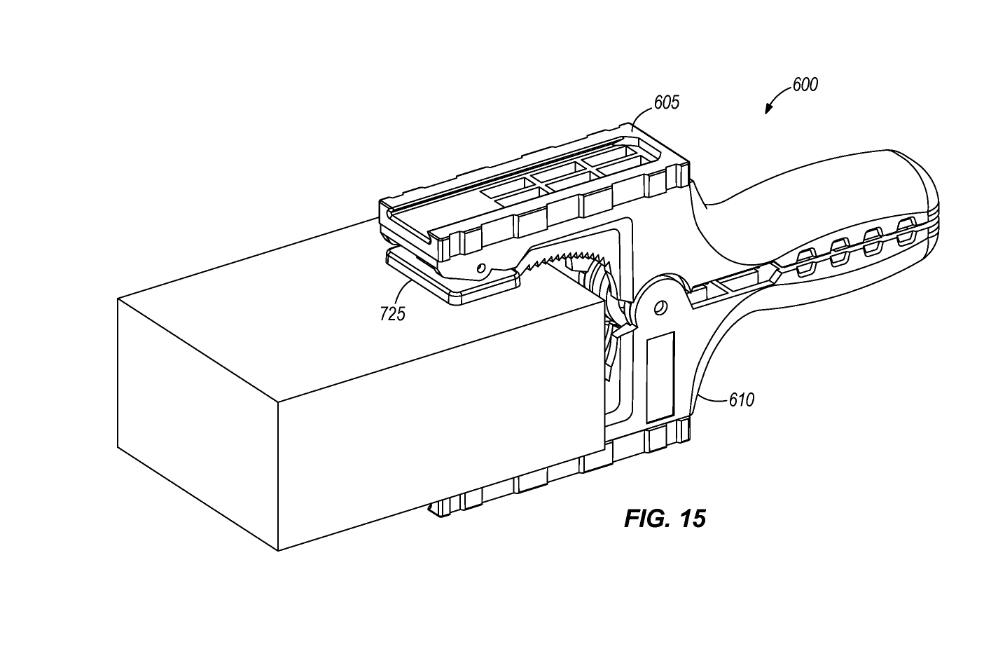

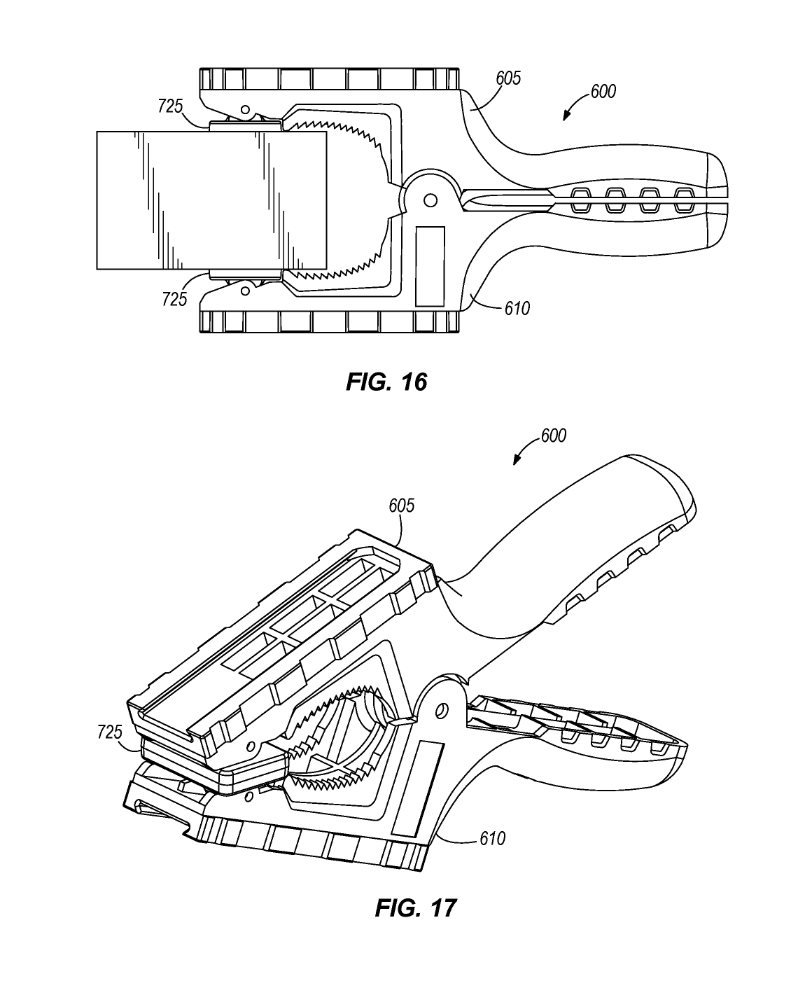

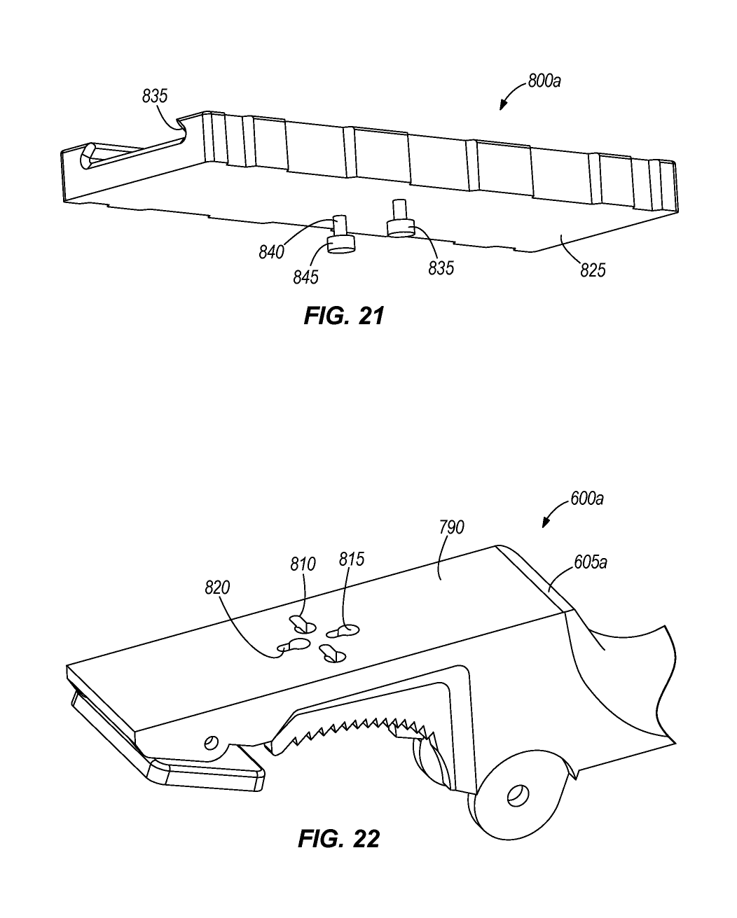

FIG. 21 illustrates the first movable attachment interface 800a which includes a substantially planar bottom surface 825, and a dovetail fit 830 opposite the bottom surface 825. The dovetail fit 830 is similar to the dovetail fit illustrated in FIGS. 1-18 and is sized to receive a mating dovetail fit on the holder unit 744. Of course other constructions could employ different attachment techniques and fits to attach the holder unit 744 to the first attachment interface 800a. Several of these different approaches were discussed with regard to FIGS. 1-18 and are equally applicable to the constructions of FIGS. 19-26.

Two mushroom studs 835 extend outward from the bottom planar surface 825. Each mushroom stud 835 includes a cylindrical neck portion 840 and a cylindrical head portion 845. The head portion 845 has a larger diameter than the neck portion 840.

As illustrated in FIGS. 19 and 20, the mushroom studs 835 are sized such that the large diameter head 845 can pass through the large diameter portion 815 of the apertures 810 but cannot pass through the smaller diameter slot portions 820 of the apertures 810. The neck 840 is sized to fit through both the large diameter portion 815 and the smaller diameter slot 820. Thus, the heads 845 are inserted into the desired apertures 810 and then the first attachment member 800a is slid along the slot portions 820 to lock the movable member 800a in place. As illustrated in FIG. 19, the first movable attachment member 800a can be positioned in two orientations in which a long axis of the attachment member 800a is substantially parallel with the long axis of the clamp 600a. Alternatively, the first movable attachment member 800a can be positioned in two orientations as illustrated in FIG. 20. In these positions, the long axis of the movable member 800a is approximately normal to the long axis of the clamp 600a. Of course other arrangements are possible when other aperture pairs are provided.

The arrangement of FIGS. 19-22 allows a user to position the movable attachment interface 800a, and therefore the holder unit 744 at one of four orientations to improve access to the accessories. A first orientation is illustrated in FIG. 19. In this orientation, the movable attachment interface 800a is arranged such that its long axis is substantially parallel to the long axis of the clamp 600a and the open end of the dovetail fit 830 is near the jaw end 620 of the clamp 600a. A second orientation uses the same apertures but positions the open end of the dovetail fit 830 near the handle end 615 of the clamp 600a. A third orientation is illustrated in FIG. 20. In this orientation, the attachment interface 800a is rotated 90 degrees with respect to its position in FIG. 19. In a fourth orientation, the attachment interface 800a is rotated 180 degrees from the position illustrated in FIG. 20. In the fourth orientation, the attachment interface 800a engages the same apertures as those used in the third orientation.

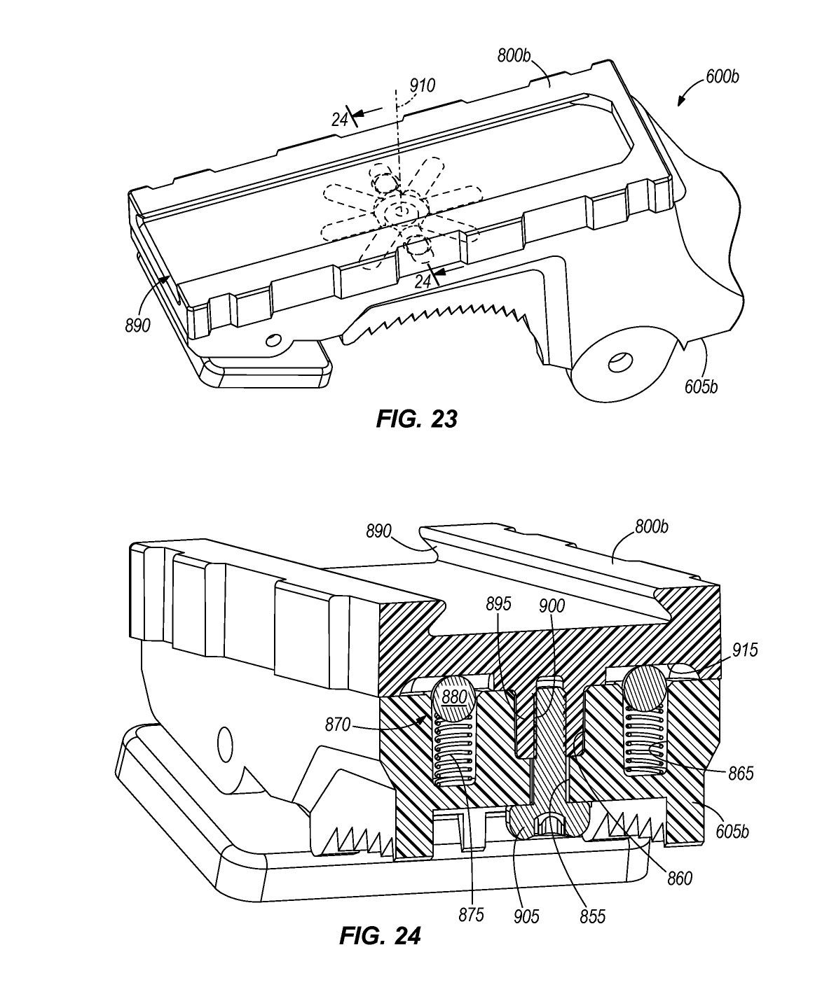

FIGS. 23-26 illustrate another construction of an upper jaw 605b for a clamp 600b which includes a second movable attachment interface 800b. As with the construction of FIGS. 19-22, a top surface 850 of the upper jaw 605b is substantially planar. A central aperture 855 is formed in the upper jaw 605b and passes through the upper jaw 605b. A counterbore 860 is formed from the top surface 850 such that the aperture has a larger diameter near the top surface 850. Two side apertures 865 extend part way through the upper jaw 605b from the top surface 850. In the illustrated construction, the apertures 855 are positioned on either side of the central aperture 855 along a line that is substantially normal to the long axis of the clamp 605b. However, other positions for these apertures 865 could be employed if desired.

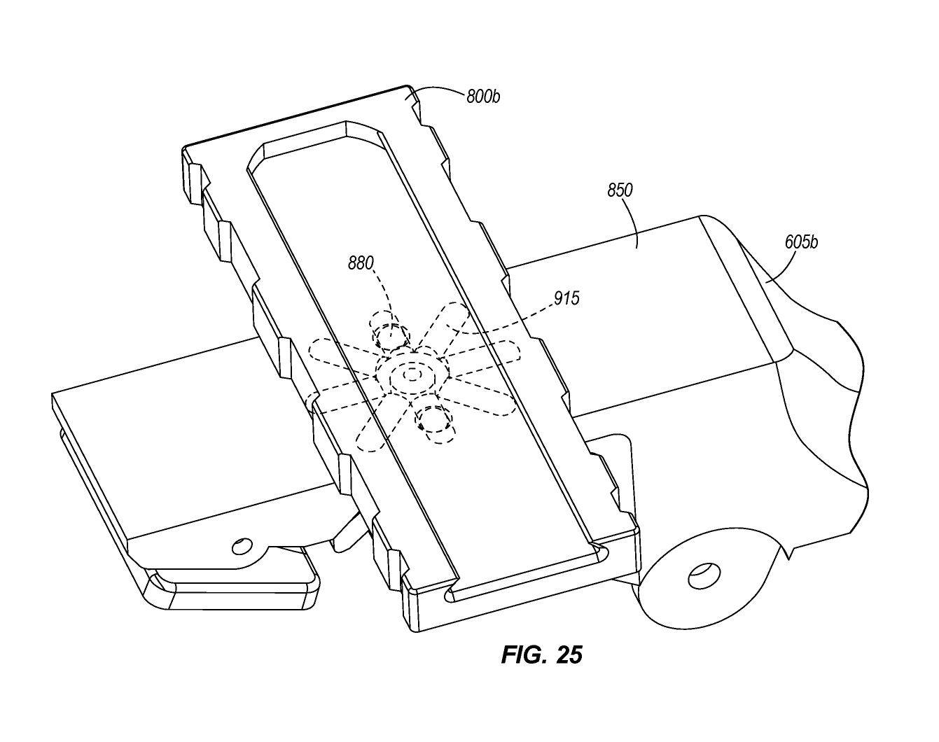

A ball detent mechanism 870 is positioned within each of the side apertures 865 as illustrated in FIG. 24. Each ball detent mechanism 870 includes a spring 875 having a first end in contact with the bottom of the side aperture 865 and a second end that supports a ball 880 that is sized to fit within the side aperture 865. The spring 875 is sized to support the ball 880 above the top surface 850 when no other force is applied to the ball 880. A locking member may be employed to hold the ball detent mechanism 870 within the aperture 865 if desired. However, preferred constructions do not employ a locking member. Rather, the second movable attachment interface 800b functions as a locking member as will be discussed below.

The second movable attachment interface 800b is similar to the first movable attachment interface 800a in that it includes a substantially planar bottom surface 885 and a dovetail fit 870 opposite the planar bottom surface 885. As noted, other attachment methods could be employed in place of the dovetail fit 890. In those constructions, the dovetail fit 890 would be omitted and replaced with the proper configuration for the particular attachment method being employed.

A post 895 extends downward from the planar bottom surface 885 and facilitates attachment of the second attachment interface 800b to the upper jaw 605b. The post 895 is a substantially cylindrical member sized to fit within the counterbore portion 860 of the central aperture 855. A center bore 900 is formed in the post 895 and is sized to receive an attachment fastener 905. The fastener 905 passes through the upper jaw 605b from the bottom surface 885 and engages the second movable attachment interface 800b in a way that allows the attachment interface 800b to rotate about an axis 910 centered on the post 895 but that inhibits axial movement along that axis 910. In one construction, the fastener 905 threadably engages the post 895. In other constructions, an adhesive attaches the fastener 905 to the post 895. In still other constructions, a combination of threads and adhesive are employed. As one of ordinary skill in the art will realize, many alternative attachment systems could be employed if desired.

A plurality of slots 915 are formed in the bottom planar surface 885 of the attachment interface 800b and extend radially outward from the post 895. The slots 915 have a width that is about equal to the diameter of the balls 880 and a depth of about half the diameter of the balls 880. In preferred constructions, the slots 915 have a semi-circular cross-section that facilitates receipt of the balls 880. In the illustrated construction, the slots 915 are arranged in four pairs which will allow for eight different orientations of the attachment interface 800b. Of course, other constructions could employ more pairs of slots 915 or fewer pairs of slots 915 as desired. In constructions that employ more pairs of slots 915, the size of the balls 880 would likely need to be reduced from those shown to provide the necessary space.

It should be noted that while the illustrated construction includes a pair of ball detents 870 and pairs of slots 915 to receive the balls 880, other constructions could employ a single ball detent mechanism 870 that is received in a single slot 915 or even a single semi-spherical aperture if desired. Furthermore, still other constructions could employ three or more ball detent mechanisms 870 if desired.

FIGS. 23, 25, and 26 illustrate the second attachment interface 800b positioned in three of eight possible orientations. When positioned in one of the possible orientations, the springs 875 bias the balls 880 upward and into the slots 915. With the balls 880 in the slots 915, unwanted rotation of the attachment interface 800b is inhibited. To rotate the interface 800b to a different position, the user applies a torque to the interface 800b. As the interface 800b rotates, the balls 880 are forced downward against the spring force until they disengage with the slots 915. The user than rotates the interface 800b until the balls 880 engage the next slots 915. The springs 875 bias the balls 880 into the slots 915 to again inhibit unwanted rotation. The second attachment interface 800b also inhibits removal of the balls 880 as its axial position along the axis 910 is substantially fixed when the second attachment interface 800b is coupled to the fastener 905.

FIG. 23 illustrates one orientation in which the long axis of the attachment interface 800b is substantially parallel to the long axis of the clamp 600b and the open end of the dovetail fit 870 is adjacent the jaw end 620 of the clamp 600b. A second orientation employs the same slots 915 but is rotated 180 degrees such that the open end of the dovetail fit 890 is positioned toward the handle end 615 of the clamp 600b.

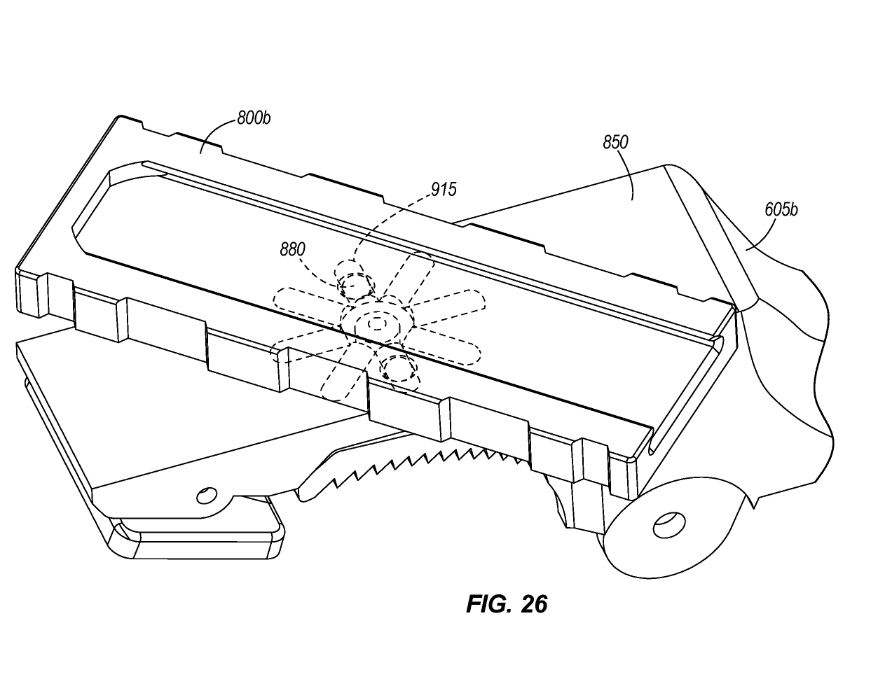

FIG. 25 illustrates a third orientation in which the long axis of the attachment interface 800b is substantially normal to the long axis of the clamp 600b. A fourth orientation uses the same slots 915 but is rotated 180 degrees from the position illustrated in FIG. 25.

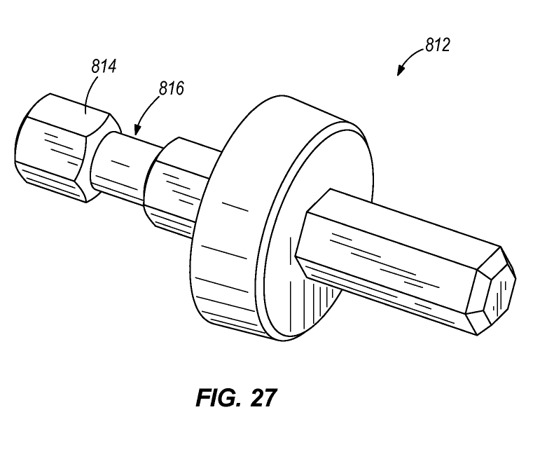

FIG. 26 illustrates a fifth orientation in which the attachment interface 800b is rotated 45 degrees counterclockwise with respect to the position illustrated in FIG. 25. A sixth orientation employs the same slots 915 with the attachment interface 800b rotated 180 degrees from that illustrated in FIG. 26. While not illustrated, a seventh orientation exists in which the attachment interface 800b is rotated 45 degrees clockwise with respect to the position illustrated in FIG. 25. An eighth orientation employs the same slots 915 with the attachment interface 800b rotated 180 degrees from the clockwise position of the seventh orientation.

Thus, the construction of FIGS. 19-22 is able to orient the holder unit 744 of the bit exchange system in one of four different orientations without moving the clamp 600a. Similarly, the construction of FIGS. 23-26 is able to orient the holder unit 744 in one of eight different orientations without moving the clamp 600b.

In use, the clamp 600 of FIG. 18 is attached to an article near a work site such that the user is able to easily access the various tool bits and/or other contents held in the holder unit 744. The user does not have to search for or even grasp the bits or the holder unit 744 between operations, making the exchange of bits a simple, one-handed operation (i.e., the one hand that grasps the tool to which the bits are exchanged). If the constructions of FIGS. 19-26 are being employed, the user can first position the clamp 600a, 600b and then orient the holder unit 744 in the most convenient of the available positions.

FIG. 27 illustrates driver bit 812 or arbor for use with an impact drill or hammer drill that operates not only to rotate a tool bit but also to “hammer” or repeatedly axially impact the workpiece. Thus, the driver bit 812 is provided with a hex-shaped shank 814 that includes a circumferential groove 816. The shank 814 is received into the chuck of the impact drill and the groove 816 is engaged by a detent so that the hammering force is efficiently conveyed from the chuck of the impact drill to the driver bit 812. The opposite end of the driver bit 812 is selectively engageable with any one of a plurality of quick-release adapters to which each of a plurality of tool bits is coupled, as described above, so that rapid, hands-free exchange of tool bits may be accomplished.

The foregoing detailed description has described only a few of the many forms that this invention can take. For this reason, this detailed description is intended by way of illustration, and not by way of limitation.

What is claimed is:

1. A bit exchange system for use with a tool, the bit exchange system comprising:
a driver bit engageable with the tool and defining an axis;
a plurality of adapters, each having a first end configured to engage the driver bit along the axis and a second end configured to retain a tool bit;
a plurality of tool bits, each of which is coupled to the second end of one of the plurality of adapters; and
a holder unit having a plurality of receptacles for receiving the plurality of adapters,
wherein each of the plurality of adapters is insertable into and removable from the respective receptacle with a motion substantially perpendicular to the axis while engaged by the driver bit.

2. The bit exchange system of claim 1, wherein the holder unit is provided with a wrist strap.

3. The bit exchange system of claim 1, wherein the holder unit is coupled with an article configured to receive at least a portion of a user's hand and wrist.

4. The bit exchange system of claim 3, wherein the article includes a thumb hole.

5. The bit exchange system of claim 1, wherein the holder unit includes a first portion in which the plurality of receptacles are formed and a second portion extending substantially perpendicular to the first portion.

6. The bit exchange system of claim 5, wherein the holder unit further includes a guard portion extending from the second portion in a direction substantially parallel with the axis.

7. The bit exchange system of claim 5, wherein a plurality of magnets are positioned on the second portion of the holder unit, each of the plurality of magnets being substantially aligned with one of the plurality of receptacles to magnetically attract a corresponding one of the plurality of adapters.

8. The bit exchange system of claim 1, further comprising a clamp having a pair of opposed, pivotally attached jaws, wherein the holder unit is coupled to the clamp.

9. The bit exchange system of claim 8, wherein the holder unit is movably coupled to the clamp and positionable in at least two different orientations on the clamp.

10. The bit exchange system of claim 1, wherein the holder unit includes a fastener receptacle.

11. The bit exchange system of claim 1, wherein the holder unit includes a wedge portion adjacent each of the plurality of receptacles, each wedge portion being configured to wedge a sleeve of one of the plurality of adapters from a closed position to an open position when the one of the plurality of adapters is inserted into one of the plurality of receptacles with a motion substantially perpendicular to the axis.

12. The bit exchange system of claim 1, wherein the driver bit is a male driver bit, the first end of each of the plurality of adapters being configured to receive the male driver bit along the axis.

13. A bit exchange system for use with a tool, the bit exchange system comprising:
a driver bit engageable with a tool and defining an axis;
an adapter having a first end configured to selectively engage the driver bit along the axis and a second end configured to retain a tool bit, the adapter further including a sleeve that is axially movable between an open position that allows substantially free insertion and removal of the driver bit into and out of the first end and a closed position in which axial removal of the driver bit from the first end is inhibited;
a tool bit coupled to the second end of the adapter; and
a holder unit including a receptacle configured to receive the adapter and a wedge portion adjacent the receptacle, the wedge portion being configured to wedge the sleeve from the closed position to the open position when the adapter is moved into the receptacle.

14. The bit exchange system of claim 13, wherein the holder unit is provided with a wrist strap.

15. The bit exchange system of claim 13, wherein the holder unit is coupled with an article configured to receive at least a portion of a user's hand and wrist.

16. The bit exchange system of claim 15, wherein the article includes a thumb hole.

17. The bit exchange system of claim 13, wherein the holder unit further includes a guard portion extending in a direction substantially parallel with the axis.

18. The bit exchange system of claim 13, wherein a magnet is positioned on the holder unit and substantially aligned with the receptacle to magnetically attract the adapter.

19. The bit exchange system of claim 13, further comprising a clamp having a pair of opposed, pivotally attached jaws, wherein the holder unit is coupled to the clamp.

20. The bit exchange system of claim 19, wherein the holder unit is movably coupled to the clamp and positionable in at least two different orientations on the clamp.

21. The bit exchange system of claim 13, wherein the holder unit includes a fastener receptacle.

22. The bit exchange system of claim 13, wherein the receptacle has an opening configured to receive the adapter in a direction substantially perpendicular to the axis.

23. The bit exchange system of claim 13, wherein the holder unit is configured to retain the sleeve in the open position while the adapter is positioned in the receptacle.

24. The bit exchange system of claim 13, wherein the holder unit includes a second receptacle to selectively receive a second adapter, the second adapter having a first end configured to selectively engage the driver bit along the axis and a second end configured to retain a second tool bit.

25. A method of coupling and de-coupling a tool bit with a tool, the method comprising:
engaging a driver bit with the tool;
engaging a tool bit with an adapter;
storing the adapter and the tool bit in a holder unit such that a sleeve of the adapter is held in an open position that allows substantially free insertion and removal of the driver bit into and out of the adapter;
inserting the driver bit into the adapter with a first motion while the adapter is stored in the holder unit;
removing the adapter and the tool bit from the holder unit with a second motion substantially perpendicular to the first motion;
returning the adapter and the tool bit to the holder unit with a third motion, which is substantially a reverse of the second motion, the sleeve of the adapter being wedged open by contact with the holder unit during the third motion to release a locking engagement between the driver bit and the adapter and allow the driver bit to be freely removed from the adapter; and
disengaging the driver bit from the adapter with a fourth motion, which is substantially a reverse of the first motion.

26. The method of claim 25, wherein the driver bit is engaged with and disengaged from the adapter and the adapter and the tool bit are removed from and returned to the holder unit without grasping the driver bit, the adapter, or the tool bit.

27. The method of claim 25, wherein the adapter and the tool bit are removed from and returned to the holder unit with the use of only a single hand to grasp the tool, leaving a user's other hand free.
